(19) United States
(12) Patent Application Publication
(10) Pub. No.: US 2006/0008782 A1
(43) Pub. Date: Jan. 12, 2006

(54) Device for teaching phonetic alphabet

(76) Inventor: Jennette L. Williams, Glen Ridge, NJ (US)

Correspondence Address: PAUL R. GAUER, 347 FRANKLIN STREET, BLOOMFIELD, NJ, 07003, US

(21) Appl. No.: 10/886,128

(22) Filed: Jul. 8, 2004

(51) Int. Cl. G09B 19/04

(52) U.S. Cl. 434/185

(57) ABSTRACT

Device for teaching children phonetic alphabet sounds comprised of an elbow tube connected to the base of a “T” tube. The elbow tube may be rigid or flexible. The “T” tube may have a cap on one end to direct sound.

### PRIOR ART

This invention relates to teaching aids, more particularly to a device for teaching phonetic alphabet.

Various devices have been invented to enhance breathing or speech, some of which incorporate tubular connections.

A gas mask patented by O. F. Wagenhorst on Jan. 25, 1921 under U.S. Pat. No. 1,366,437 includes feeding and air intake tubes.

A nasal positive airway pressure mask patented by Robert M. Landis and Wayne W. Disanza under U.S. Pat. No. 5,657,752 on Aug. 19, 1997 has an elbow shaped aperature.

A gas mask with speech membrane was patented by Gilbert Vandeputte on Sep. 18, 1990 under U.S. Pat. No. 4,957,106 is composed of flexible hose.

A breathing mask with speaking diaphragm was patented Jul. 12, 1988 by Helmut Ryback under U.S. Pat. No. 4,756,308.

A ventilation tube swivel for connecting an endotrachial tube to a supply tube was patented by Richard E. Webb and Charles S. L. Hommedieu on Jun. 30, 1987 under U.S. Pat. No. 4,676,241.

A speech simulator patented by Nikolai G . Zagoruiko and Alexander B. Kolmogorov under U.S. Pat. No. 4,109,103 on Aug. 22, 1978 contained a complex series of pipes connected with a sourdine intended to simulate natural speech.

A demand regulator patented on Sep. 7, 1976 by Justine W. Mills, Jr. under U.S. Pat. No. 3,978,854 includes an artificial diaphragm.

A compound swivel adaptor invented by J. W. Phillips and patented Jan. 21, 1958 under U.S. Pat. No. 2,820,651 is a swiveling tube for use in anesthesia.

A nasal mask providing an air tight seal around the nose of wearer was patented Feb. 27, 2001 by Kevin A Rudolph under U.S. Pat. No. 6,192,886, B1.

Although some of these inventions make use of tubular parts, none physically resembles this invention and none is directed toward teaching the phonetic alphabet.

### SUMMARY OF THE INVENTION

This is a device for teaching children phonetic alphabet sounds comprised of a “T” shaped tube connected at the base of the “T” to an elbow shaped tube. The “T” shaped tube may have a cap on an end of the “T” to direct sound. Objects of the invention include simplicity and practicality of design.

### DRAWINGS

FIG. 1. Perspective view

FIG. 2. Demonstrative view

FIG. 3. Alternate embodiment view

FIG. 4. Series view

FIG. 5. Cross section view from FIG. 1

### PREFERRED SPECIFICATIONS

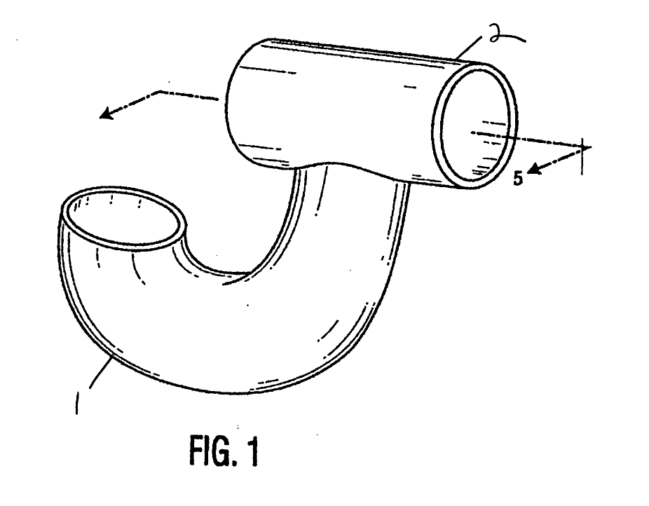

FIG. 1. Shows an elbow tube (1) connected at one end to the base of a “T” tube (2).

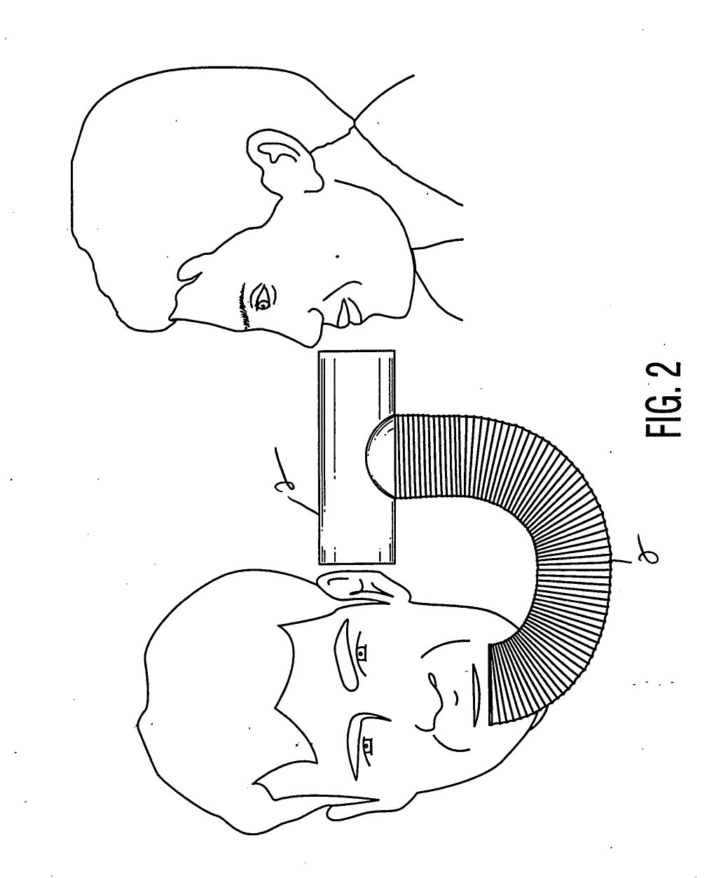

FIG. 2. Demonstrates the invention in use with a person making sounds into the unconnected end of elbow tube (1) and with one end of “T” tube (2) placed by that same persons ear and the other end of “T” tube (2) placed by the mouth of a second person, who initiates the sound, which the first person then repeats.

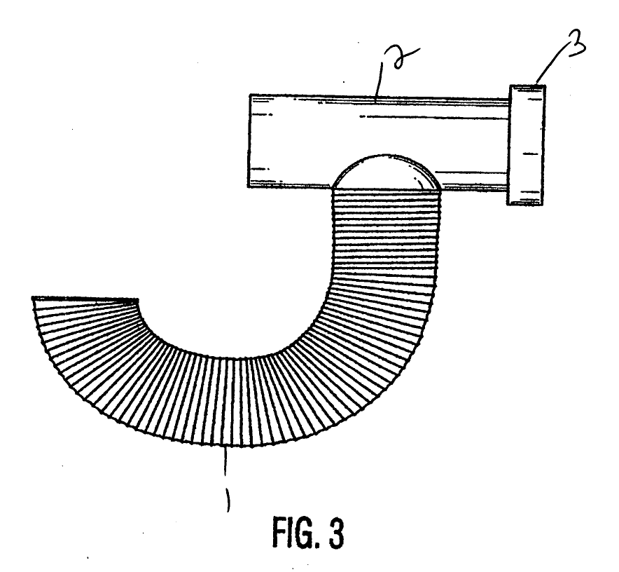

FIG. 3. Depicts an alternate embodiment wherein elbow tube (1) consist of flexible hose connected in a manner similar to FIG. 1 and forming the base of “T” tube (2). This figure also contains a cap (3) on one end of the “T” tube (2) for directing sound.

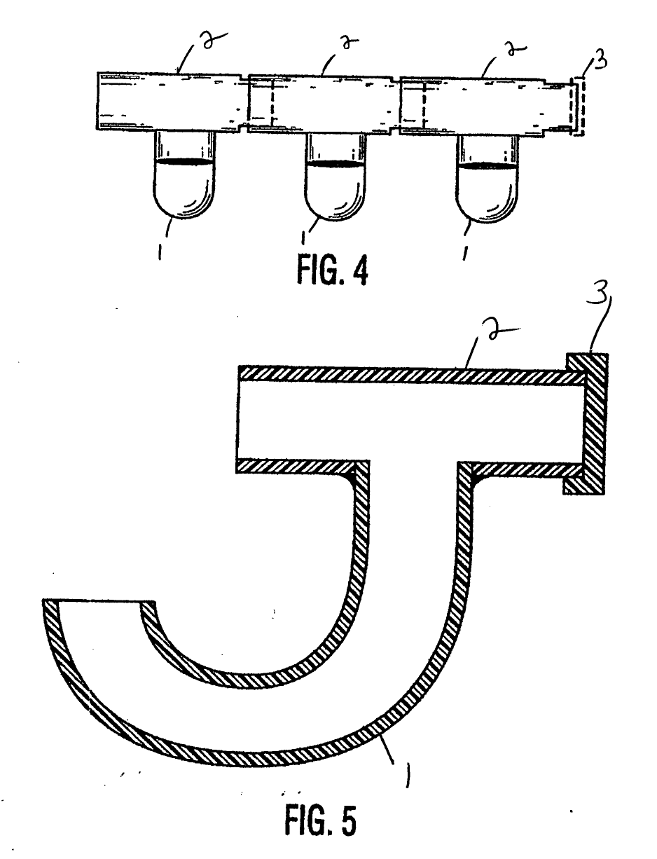

FIG. 4. Contains three subject inventions in a series with elbow tube (1) connected to “T” tube (2) but with one “T” end inserted into the opposite “T” end of an adjacent like device. A cap (3) is at the end of “T” tube (2) third in the series.

FIG. 5. Is a cross sectional view of FIG. 1 showing elbow tube (1) connected to “T” tube (2) but with a cap (3) added to one open end of “T” tube (2).

This inventor claims:

1. A speech aid device comprised of an elbow tube connected to the base of a “T” tube.

2. The device of claim 1 wherein the elbow tube is rigid.

3. The device of claim 1 wherein the elbow tube is flexible.

4. The device of claim 1 having a cap at one end of said “T” tube.
